(19) United States
(12) Patent Application Publication
(10) Pub. No.: US 2026/0095425 A1
(43) Pub. Date: Apr. 2, 2026

(54) METHOD, SERVER, AND USER TERMINAL FOR PROVIDING INFORMATION ON HIGHLIGHT TARGET MESSAGE

(71) Applicant: KAKAO CORP., Jeju-si (KR)

(72) Inventor: Woo Young PARK, Seoul (KR)

(21) Appl. No.: 19/293,575

(22) Filed: Aug. 7, 2025

(30) Foreign Application Priority Data
Sep. 27, 2024 (KR) 10-2024-0131707

(51) Int. Cl. H04L 51/046

(52) U.S. Cl. CPC H04L 51/046

(57) ABSTRACT

Proposed is a method for providing information on a highlight target message by a server. The method may include identifying relationship information between a user and at least one other user participating in a chat room. The method may also include determining an intimacy level between the user and the at least one other user based on the relationship information. The method may further include providing information on a highlight target message to a user terminal when a message transmitted to the chat room satisfies a predetermined condition related to the intimacy level.

### CROSS-REFERENCE TO RELATED APPLICATION

This application claims priority to and the benefit of Korean Patent Application No. 10-2024-0131707 filed on Sep. 27, 2024, the disclosure of which is incorporated herein by reference in its entirety.

### BACKGROUND

### Technical Field

The present disclosure relates to a method for providing information on a highlight target message by a server.

### Description of Related Technology

Recently, chat services provide group chat rooms where a plurality of users participate. These group chat rooms may be provided in forms such as anonymous chat rooms for family, friends, companies, or for information exchange. In group chat rooms, a large number of messages may be exchanged within a short time, and the accumulation of messages may hinder immediate comprehension of the content.

### SUMMARY

One aspect is to determine intimacy levels among users participating in a chat room, and to highlight and display at least one of a plurality of messages displayed in the chat room according to the intimacy levels.

Another aspect is a method for calculating intimacy levels among users based on relationship information of other users participating in a chat room with respect to a message transmitted by a user terminal to the chat room.

Another aspect is a method for providing information on a highlight target message by a server that includes: identifying relationship information between a user and at least one other user participating in a chat room; determining an intimacy level between the user and the at least one other user based on the relationship information; and providing information on a highlight target message to a user terminal when a message transmitted to the chat room satisfies a predetermined condition related to the intimacy level.

The method may further include providing, to the user terminal, a highlighting activation interface that enables activation of highlighting for the highlight target message.

The relationship information may include message-related relationship information and user-related information.

The message-related relationship information may include at least one of reply information, comment information, reaction information, and keyword information specified by the user for the message.

The message-related relationship information may include corresponding message occurrence information, and the corresponding message occurrence information may be information indicating whether a corresponding message to a reference message transmitted by the user terminal is included within a set of consecutive messages defined by a predefined criterion.

The user-related relationship information may include at least one of gift exchange information for the user, remittance information, information on whether a chat room in which the user and the at least one other user participate exists in the chat service, and information on whether the user and the at least one other user satisfy a specific relationship in the chat service.

The determining of the intimacy level may include determining a message-level intimacy score based on the message-related relationship information.

The message-level intimacy score may be determined based solely on the chat room.

The determining of the intimacy level may include determining a user-level intimacy score based on the user-related relationship information, and the user-level intimacy score may be determined based on all chat room including the chat room.

When the chat room is an anonymous chat room in which profile information of the user is not disclosed, the server may determine the relationship information based solely on the anonymous chat room when determining the intimacy level.

The method may further include, prior to determining the intimacy level, receiving the predetermined condition associated with the chat room from the user terminal.

Highlighting of the highlight target message may be determined based on content included in the highlighted message transmitted to the chat room.

The highlighted message may include at least one message among messages unread by user in the chat room and messages newly transmitted in real time by at least one other user terminal to chat room.

The method may further include, prior to determining the intimacy level, receiving reference information for determining the intimacy level among the relationship information from the user terminal.

Another aspect is a server providing information on a highlight target message that includes a memory storing instructions, and a processor configured to execute instructions to: identify relationship information between a user and at least one other user participating in a chat room; determine an intimacy level between the user and the at least one other user on the relationship information; and provide information on a highlight target message to a user terminal when a message transmitted to the chat room satisfies a predetermined condition related to the intimacy level.

Another aspect is a method for displaying a highlighted message by a user terminal that includes: displaying a highlighting activation interface that enables activation of highlighting for at least one message displayed in a chat room; and upon receiving an interaction from a user through the highlighting activation interface, displaying a highlighted message that is the at least one message to which the highlighting has been applied. The highlighted message is a message transmitted to the chat room by at least one other user terminal satisfying a predetermined condition related to an intimacy level, and the intimacy level is determined based on relationship information between the user and at least one other user participating in the chat room.

The intimacy level may include a message-level intimacy score based on relationship information related to the message and user-level intimacy score based on relationship information related to the user, and the method may further include determining the intimacy level based on at least one of the message-level intimacy score and the user-level intimacy score, which is performed prior to the displaying of the highlighted message.

The determining of the intimacy level may include
determining the message-level intimacy score based on message information related to the chat room and stored in the user terminal.

The determining of the intimacy level may include receiving information on the user-level intimacy score from a server.

Another aspect is a user terminal displaying a highlighted message that includes a memory storing instructions; and a processor configured to execute instructions to: display a highlighting activation interface that enables activation of highlighting for at least one message displayed in a chat room; and upon receiving an interaction for activating the highlighting from a user through the highlighting activation interface, display a highlighted message in which highlighting is applied to the at least one message. The highlighted message is a message transmitted to the chat room by at least one other user terminal satisfying a predetermined condition related to an intimacy level, and the intimacy level is determined based on relationship information between the user and at least one other user participating in the chat room.

### BRIEF DESCRIPTION OF THE DRAWINGS

FIG. 1 is a diagram illustrating an example of a network environment according to one embodiment of the present disclosure.

FIG. 2 is a flowchart illustrating a method in which a server of the present disclosure provides information on a highlight target message.

FIGS. 3 and 4 illustrate screens in which a user terminal of the present disclosure determines intimacy level based on relationship information and displays a highlighted message accordingly.

FIG. 5 is a flowchart illustrating a method in which a server of the present disclosure to receive reference information used to determine an intimacy level from a user terminal.

FIG. 6 schematically illustrates data used by a server of the present disclosure to determine an intimacy level.

FIG. 7 illustrates a screen where a user terminal of the present disclosure displays different highlighted messages for each chat room based on a predefined criterion related to intimacy level.

FIG. 8 illustrates a screen where a user terminal of the present disclosure displays highlighted messages within an anonymous chat room.

FIG. 9 is a flowchart illustrating a method in which a user terminal of the present disclosure displays a highlighted message.

### DETAILED DESCRIPTION

Some chat services provide highlighted messages by assigning priority or importance, whereby highlighted messages are visually distinguished from general messages. In such cases, specific messages of interest may stand out and be easily identified among other messages. Highlighted messages may enable efficient communication within group chat rooms.

Such highlighted messages may be applied uniformly to all users in a chat room. Alternatively, customized highlighted messages may be provided individually to each user. That is, through the highlighting function, message priority may be set to enhance communication efficiency in chat services.

Hereinafter, embodiments disclosed in the present specification will be described in detail with reference to the accompanying drawings. Identical or similar components, regardless of the reference numerals, will be assigned the same reference numbers, and repetitive descriptions thereof will be omitted. In addition, when describing the embodiments disclosed in the present specification, if it is determined that a detailed description of related known technologies may obscure the essence of the disclosed embodiments, such detailed description will be omitted.

Terms including ordinal numbers such as “first,” “second,” and the like may be used to describe various components, but such terms are not intended to limit the components. Such terms are used solely for the purpose of distinguishing one component from another.

Singular expressions shall be understood to include plural expressions unless the context clearly indicates otherwise.

In this application, the steps described may be performed in an order different from the one listed, except when a particular causal relationship requires the listed order to be followed.

In this application, it should be understood that terms such as “comprises” or “have” are intended to specify the presence of features, numbers, steps, operations, components, parts, or combinations thereof described in the specification, but do not preclude the presence or addition of one or more other features, numbers, steps, operations, components, parts, or combinations thereof.

Hereinafter, the present disclosure will be described with reference to the attached drawings.

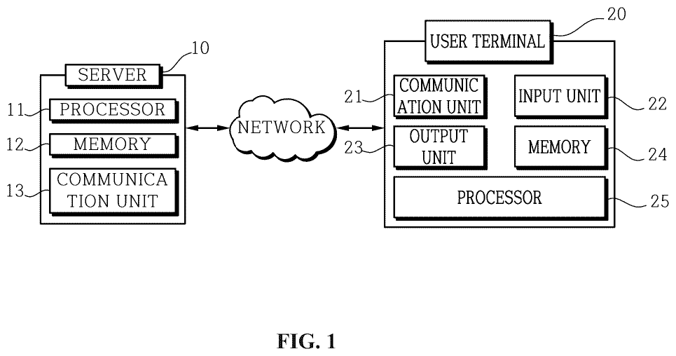

FIG. 1 is a diagram illustrating an example of a network environment according to one embodiment of the present disclosure.

A network environment according to one embodiment of the present disclosure illustrated in FIG. 1 may include a server 10 and a user terminal 20. The user terminal 20 may include at least one user terminal 20 connected to the server 10 through a network. In FIG. 1, the user terminal 20 is illustrated as an exemplary terminal used by a user.

The user terminal 20 refers to a terminal operated by a user who logs in with a user account registered on the server 10. In the present disclosure, the term “user” refers to a person using the user terminal 20, unless otherwise specified.

Hereinafter, for convenience of explanation, the user terminal 20 will be referred to as a terminal configured to display a highlighted message. However, the present disclosure should not be construed as being limited to specific functions performed by the user terminal 20.

The network is not limited to any specific communication method, and may include not only methods utilizing various types of communication networks (e.g., mobile communication networks, wired Internet, wireless Internet, and broadcasting networks), but also short-range wireless communication.

In the present disclosure, the server 10 may be a device capable of transmitting and receiving information through a network connection with the user terminal 20. The server 10 may be implemented as a computer device or a plurality of computer devices that provide commands, codes, files, content, services, and the like.

The server 10 may include a processor 11, a memory 12, and a communication unit 13.

The processor 11 controls the overall operation of the memory 12 and the communication unit 13 to provide the user terminal 20 with information on a highlight target message. The information on the highlight target message may be information on a message subject to highlighting among messages that have been transmitted to a chat room.

The memory 12 functions as a storage medium and may store multiple applications executed by the server 10, and data and commands for the operation of the server 10. In one embodiment, the memory 12 may store an application capable of providing a highlighted message via a chat room. Here, the highlighted message may refer to at least one message transmitted to the chat room, to which highlighting is applied.

The memory 12 may be implemented using various types of storage devices, such as ROM, RAM, flash drives, or hard drives, or may be provided as web storage.

The communication unit 13 may communicate with the user terminal 20 via a network in a wired/wireless manner.

The server 10 of the present disclosure may provide, to the user terminal 20 via a chat room, a highlighting activation interface that enables activation of highlighting for a highlight target message.

In the present disclosure, the server 10 may identify information on a predetermined interaction between one user and at least one other user in a chat room, and determine whether a condition related to the predetermined interaction is satisfied based on the information on the predetermined interaction. When a message transmitted to a chat room satisfies the condition, the server 10 may provide information on a highlight target message to the user terminal 20.

Here, the chat room refers to a group chat room provided by the chat service. The chat room may include a general chat room in which user profile information is disclosed and an anonymous chat room in which user profile information is not disclosed.

Information on a predetermined interaction refers to information used to determine whether a condition related to the predetermined interaction is satisfied. Specifically, relationship information may include information on interactions involving a user and interactions involving a message.

For example, the information on interactions involving a user may include at least one of: gift exchange information for the user; remittance information; information on whether there is a chat room where the user and at least one other user participate in the chat service; and information on whether the user and at least one other user satisfy a specific relationship in the chat service. In addition, information on interactions involving a message may include at least one of reply information, comment information, reaction information, and keyword information specified by the user for the message.

Here, a condition related to a predetermined interaction refers to the frequency of the interaction between the user and any other users in the chat service. The server 10 may determine whether the condition is satisfied based on information on the predetermined interaction. Here, whether the condition is satisfied may be determined based on a specific value (e.g., intimacy level).

The intimacy level may include a message-level intimacy score determined based on message-related relationship information and a user-level intimacy score determined based on user-related relationship information. The intimacy level may be determined based on the message-level intimacy score and the user-level intimacy score. For example, the intimacy level may be determined by averaging the message-level intimacy score and the user-level intimacy score.

When determining intimacy levels, the server 10 may assign weights to a plurality of items of relationship information. For example, the server 10 may assign a higher weight to reply information for a message transmitted by the user than to general conversation information between the user and other users. In addition, the server 10 may assign a higher weight to reaction information than to reply information for a message transmitted by the user.

The user of the user terminal 20 may set a predetermined condition. For example, the predetermined condition may be set as “any messages transmitted by a user with the highest intimacy level in a chat room.” In some cases, the predetermined condition may be predetermined by the operator or operating policy of the chat service.

Here, highlighting refers to a visual indication used to distinguish a highlight target message from other messages in the chat room. Highlighting may include a variety of methods. Specifically, one method for highlighting may be displaying the shape, appearance, or color of a message in a different manner. In addition, another method for highlighting may be displaying messages separately in distinct areas. In addition, yet another method for highlighting may be displaying an indicator such as “highlighted message” around the corresponding message.

Here, information on a highlight target message refers to information on a message subject to highlighting. Specifically, the highlight target message may be a message, among all the messages transmitted to a chat room, that is transmitted by another user terminal satisfying a predetermined condition related to intimacy level. When the predetermined condition related to intimacy level is satisfied, the server 10 may provide information on the highlight target message to the user terminal 20. Then, the user terminal 20 may display a highlighted message in which highlighting is applied to the highlight target message.

In some cases, when the server 10 receives a request to send a message to a chat room from another user terminal that satisfies a predetermined condition related to intimacy level, the server 10 may directly provide a highlighted message, without providing information on a highlight target message.

The user terminal 20 includes the user terminal 20 that displays a highlighted message. The user terminal 20 may include a communication unit 21, an input unit 22, an output unit 23, a memory 24, and a processor 25.

The communication unit 21 may communicate with the server 10 or other terminals in a wired/wireless manner.

The input unit 22 may receive various types of information through the user's manipulation and input actions. The input unit 22 may be a touch screen module, a keyboard, a mouse, a button, a camera, a stylus, a microphone, etc.

The user terminal 20 may receive an input indicating a user's interaction through the input unit 22. The term “interaction” refers to inputting information reflecting the user's selection or intention into the user terminal 20 by manipulating the input unit. Examples of interactions may include touching a touchscreen, clicking a mouse, typing on a keyboard, inputting sound through a microphone, capturing an image using a camera, or recognizing movement via a motion sensor, and the like.

The output unit 23 may output various information. The output unit 23 may be a display device, a speaker, a vibration generating device, a tactile generating device, etc. In some cases, the output unit 23 may be a device (e.g., Bluetooth earphone) that receives and outputs a signal by being connected to the user terminal 20 via wired or wireless communication (e.g., short-range wireless communication such as Bluetooth).

The memory 24 functions as a storage medium and may store a number of application programs running on the user terminal 20, and data and commands for the operation of the user terminal 20. This memory 24 may be provided in the form of various storage devices such as hardware, ROM, RAM, flash drive, hard drive, etc., or in the form of web storage. In one embodiment, the memory 24 may store a chat application configured to display highlighted messages with highlighting applied.

The processor 25 may execute the chat application capable of displaying a highlighted message, by controlling the overall operation of the communication unit 21, the input unit 22, the output unit 23 and the memory 24.

In the present disclosure, the user terminal 20 displays a highlighting activation interface that enables activation of highlighting for at least one message displayed in a chat room. Upon receiving an interaction from the user through the highlighting activation interface, the user terminal 20 may display at least one message as a highlighted message. Here, the highlighted message may be a message transmitted to the chat room by at least one other user's terminal. Here, at least one other user may be a user who satisfies a condition related to a predetermined interaction with the user of the user terminal 20.

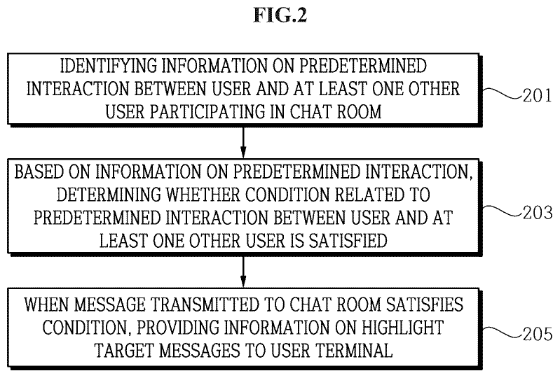

Hereinafter, one embodiment of a method for providing information on a highlight target message by the server 10 of the present disclosure will be described with reference to FIGS. 2 to 4.

FIG. 2 is a flowchart illustrating a method for providing information on a highlight target message by the server 10 of the present disclosure.

In operation 201, the server 10 checks information on a predetermined interaction between the user and at least one other user participating in the chat room.

The server 10 may identify relationship information between users participating in the chat room. In some cases, the server 10 may identify relationship information associated with all users (or at least some users) who have signed up for the chat service. Here, the relationship information may include at least one of message-related relationship information and user-related relationship information.

The message-related relationship information may include at least one of reply information, comment information, reaction information, and keyword information specified by the user for the message. For example, the server 10 may identify reply, comment, and reaction information of other user terminals to a message transmitted by the user terminal 20. Conversely, the server 10 may identify reply, comment and reaction information of the user terminal 20 with respect to a message transmitted by another user terminal.

The server 10 may identify a message that corresponds to keyword information transmitted to the chat room by another user terminal. For example, when keyword information specified by the user is “whiskey,” the server 10 may identify a message including the keyword “whiskey” among messages transmitted to the chat room by other user terminals.

In addition, the message-related relationship information may include corresponding message occurrence information. Specifically, the corresponding message occurrence information may be information indicating whether a corresponding message to a reference message transmitted by the user terminal 20 is included within a set of consecutive messages defined by a predefined criterion. The predefined criterion may be defined, for example, as n messages transmitted before or after the reference message, or a time period before or after the reference message.

For example, when the user terminal 20 transmits the reference message to the chat room and another user terminal transmits a reply message (corresponding message) to the reference message among ten messages transmitted after the reference message, the reply message may be included in the corresponding message occurrence information.

The user-related relationship information may include at least one of: gift exchange information for the user, information on remittance; information on whether there is a chat room in which the user and at least one other user participate in the chat service; and information on whether the user and at least one other user satisfy a specific relationship in the chat service.

For example, the server 10 may identify information (gift exchange information) regarding any gifts exchanged between the user terminal 20 and any other user terminals. In addition, the server 10 may identify information (remittance information) on money exchanged between the user terminal 20 and any other user terminals.

The server 10 may identify information on whether there is a chat room where the user and at least one other user participate in the chat service. Specifically, the server 10 may identify whether there is a one-on-one chat room between the user and at least one other user and whether there is a group chat room including the user and at least one other user.

The server 10 may identify information on whether the user and at least one other user satisfy a specific relationship in the chat service. Here, the specific relationship may include a friend relationship, a subscription relationship, a following relationship, or the like. In addition, the specific relationship may be a case in which at least one of the user and another user has stored the other's phone number.

In operation 203, the server 10 determines whether a condition related to the predetermined interaction between the user and at least one other user is satisfied, based on information on the predetermined interaction.

The server 10 may determine an intimacy level between the user and at least one other user participating in the chat room. The intimacy level may include a message-level intimacy score determined based on message-related relationship information and a user-level intimacy score determined based on user-related relationship information.

The intimacy level may be determined based on the message-level intimacy score and the user-level intimacy score. For example, the intimacy level may be determined by averaging the message-level intimacy score and the user-level intimacy score. Alternatively, the intimacy level may be determined by summing the message-level intimacy score and the user-level intimacy score. In some cases, the message-level intimacy score and the user-level intimacy score may be assigned different weights. In such cases, the intimacy level may be determined based on the weights assigned to the message-level intimacy score and the user-level intimacy score.

The intimacy level may be quantified as a numerical value. For example, based on relationship information, the server 10 may determine the intimacy level as a numerical value ranging from 0 to 10. Alternatively, the server 10 may determine the intimacy level as a categorical grade (e.g., high, medium, or low) instead of a numerical value.

The entity that determines an intimacy level may vary depending on the type of intimacy level. Specifically, the user-level intimacy score may be determined by the server 10. The server 10 may determine the user-level intimacy score based on all chat rooms in which the user participates in the chat service, or based solely on a specific chat room.

Alternatively, the message-level intimacy score may be determined by the user terminal 20. Specifically, the message-level intimacy score may be determined based on chat room message information stored in the user terminal 20. In such cases, the user terminal 20 does not need to transmit the stored messages to the server 10, which may be advantageous in terms of protecting personal information.

Thereafter, the server 10 may receive information on the message-level intimacy score from the user terminal 20 to determine the intimacy level. Alternatively, the server 10 may provide information on the user-level intimacy score to the user terminal 20, and the user terminal 20 may determine the intimacy level.

A method for determining an intimacy level may vary depending on the type of intimacy level. Specifically, when the type of intimacy level is message-level intimacy score, the server 10 may determine the message-level intimacy score based solely on a specific chat room in which the user is participating in the chat service. However, when the type of intimacy level is user-level intimacy score, the server 10 may determine the user-level intimacy score based on all chat rooms in which the user is participating in the chat service.

A method for determining intimacy level may vary depending on the type of chat room. Here, the type of chat room may include a general chat room in which profile information of participants in the chat room is disclosed and an anonymous chat room in which profile information of participants in the chat room is not disclosed.

Specifically, when the chat room is a general chat room, the server 10 may determine the intimacy level based on all chat rooms in which the user is participating in the chat service. However, when the chat room is an anonymous chat room, the server 10 may determine the intimacy level based solely on a specific chat room in which the user is participating in the chat service.

In operation 205, when a message transmitted to the chat room satisfies the condition related to the predetermined interaction between the user and at least one other user, the server 10 provides information on a highlight target message to the user terminal 20.

The server 10 may receive a predetermined condition from the user terminal 20. Here, the predetermined condition may be set differently.

For example, the predetermined condition may be defined as a message transmitted by another user having the highest intimacy level in the chat room. In such cases, only messages transmitted by only a specific user terminal in the chat room may satisfy the predetermined condition. In some cases, when a plurality of users share the highest intimacy level, messages transmitted by a plurality of user terminals may satisfy the predetermined condition.

In another example, the predetermined condition may be set to a message transmitted by another user having an intimacy level equal to or higher than a predefined threshold. For example, the predetermined condition may correspond to an intimacy level of 6 or greater, assuming that the intimacy level is determined as a numerical value ranging from 0 to 10. In this case, messages transmitted by the plurality of user terminals having an intimacy level of 6 or higher may satisfy the predetermined condition.

In some cases, when all other participants in the chat room do not satisfy the predetermined condition, for example, when all other users have an intimacy level lower than 6 in the above exemplary case, a message transmitted by another user terminal with the highest intimacy level may be automatically regarded as satisfying the predetermined condition.

The predefined threshold may be set differently for each chat room. For example, the predefined threshold may be set such that in the first chat room, the intimacy level is “high”; in the second chat room, the intimacy level is “medium”; and in the third chat room, the intimacy level is “low”.

The server 10 may provide information on a highlight target message to the user terminal 20. Specifically, when a message transmitted to a chat room satisfies a predetermined condition related to intimacy level, the server 10 may provide information on a highlight target message among the messages transmitted to the chat room to the user terminal 20. When the user terminal 20 receives the user's interaction to activate highlighting through a highlighting activation interface, the user terminal 20 may display a highlighted message in which highlighting is applied to the highlight target message.

Here, the highlight target message may be at least one message among messages unread by user in the chat room and messages newly transmitted in real time by at least one other user terminal to chat room. In some cases, the highlight target message may be at least one of the messages included in the chat room.

Highlighting a message may include a variety of methods. Specifically, the method for highlighting may be changing the shape, appearance, and color of the message differently. In addition, another method for highlighting may be displaying messages separately in distinct areas. In addition, yet another method for highlighting may be displaying an indicator such as “highlighted message” around the corresponding message.

The method for highlighting may be determined by the content of a message transmitted by another user. For example, when a message transmitted by another user terminal includes keyword information specified by the user, the method for highlighting may be changing a color or size of the keyword.

Alternatively, when a message is transmitted by another user terminal as a reply to a message transmitted by the user terminal 20 to the chat room, the method for highlighting may be highlighting the original message from the user terminal 20 and the reply message from the other user terminal in a color distinguishable from other messages in the chat room.

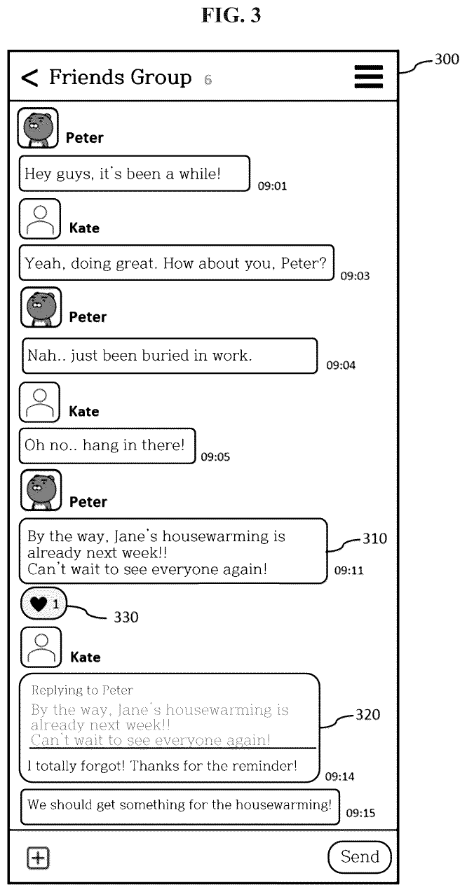

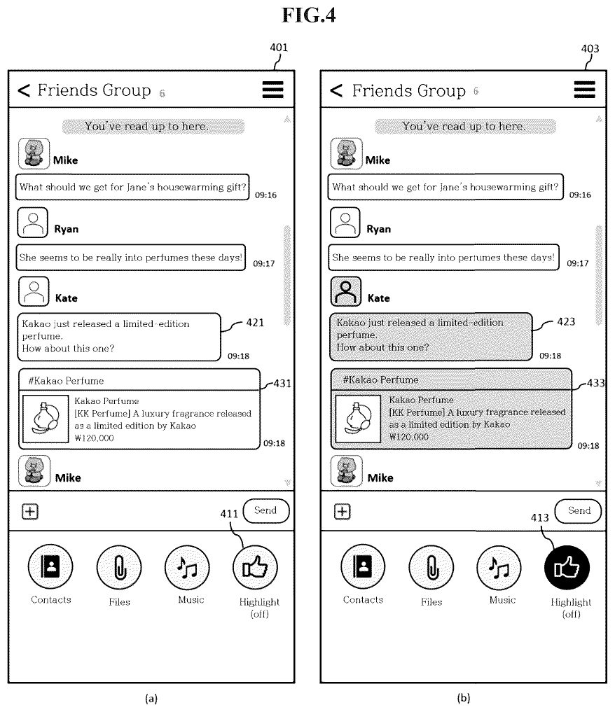

Hereinafter, with reference to FIGS. 3 and 4, an example of how the user terminal 20 displays a highlighted message according to one embodiment of the present disclosure will be described.

FIG. 3 illustrates a screen where the server 10 according to one embodiment of the present disclosure identifies relationship information between the user and other users participating in a chat room.

Referring to FIG. 3, the server 10 may identify relationship information between a user (Peter) and another user (Kate). Specifically, the relationship information may include conversation information, reply information, and reaction information between the user and the other users in the chat room.

For example, the server 10 may identify reply information “I totally forgot! Thanks for the reminder!” 320 as a reply to the message “By the way, Jane's housewarming is already next week!! Can't wait to see everyone again!” 310 transmitted by Peter. In addition, the server 10 may identify reaction information 330 associated with the message “By the way, Jane's housewarming is already next week!! Can't wait to see everyone again!” 310. In this case, the server 10 may determine that Peter and Kate have the highest intimacy level based on the relationship information described above in Friends Group 300.

In addition, the relationship information may include corresponding message occurrence information. The corresponding message occurrence information may indicate whether a corresponding message corresponding to the reference message 310 transmitted by the user terminal 20 to the chat room is included in a set of multiple consecutive messages 330 defined based on a predetermined criterion.

For example, the corresponding message may be transmitted in the form of a reply message. For example, when Kate sends a reply message (corresponding message) 320 in response to the reference message 310 transmitted by Peter, the reply message 320 may be included in the corresponding message occurrence information.

In another example, the corresponding message may be transmitted in the form of a regular message. For example, even if it is not a reply message 320, a message such as Kate's “Yeah, I'm doing great. How about you, Peter?” may also be regarded as a corresponding message to Peter's reference message, “Hey guys, it's been a while! How's everyone doing?” as shown in FIG. 3. In this case, Kate's message “Yeah, I'm doing great. How about you, Peter?” may be included in the corresponding message occurrence information.

FIG. 4 illustrates a screen where the user terminal 20 displays a highlighted message according to one embodiment of the present disclosure.

In FIG. 4, (a) illustrates a screen where the user terminal 20 displays a highlighting activation interface 411.

In FIG. 4, (b) illustrates a screen where the user terminal 20 displays highlighted messages 421 and 423.

Referring to (a) of FIG. 4, the user terminal 20 may display the highlighting activation interface 411. The user terminal 20 may receive information on a highlight target message from the server 10. Then, upon receiving an interaction from the user with the highlighting activation interface 411, the user terminal 20 may apply highlighting to at least one message transmitted to a chat room 401.

The highlight target message may be at least one message among messages unread by the user in the chat room 401. Specifically, when providing information on a highlight target message, the server 10 may designate at least one of the unread messages as highlight target messages 421 and 431.

Referring to FIG. 4(b), upon receiving an interaction from the user with a highlighting activation interface 413, the user terminal 20 may apply highlighting to the messages 423 and 433 transmitted to the chat room 401. In this case, the highlighting activation interface 413 may be displayed in an activated state (e.g., Highlight On) 413.

The user terminal 20 may display highlighted messages 423 and 433 to which highlighting has been applied to the highlight target messages. For example, the method for highlighting may be displaying a highlight target message in a color distinguishable from other messages transmitted to a chat room.

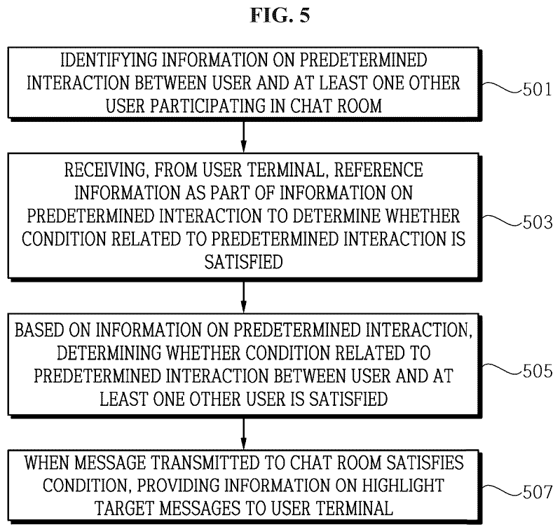

Hereinafter, with reference to FIGS. 5 to 8, one embodiment will be described in which the server 10 of the present disclosure receives, from the user terminal 20, reference information as part of information on a predetermined interaction to determine whether a condition related to the predetermined interaction is satisfied.

FIG. 5 is a flowchart illustrating a method in which the server 10 of the present disclosure receives, from the user terminal 20, reference information as part of information on a predetermined interaction to determine whether a condition related to the predetermined interaction is satisfied.

For convenience of explanation, the description of operations in FIG. 5 that are substantially the same as those in FIG. 2 will be omitted, and reference may be made to FIG. 2.

Since operations 501, 505, and 507 are substantially the same as operations 201, 203, and 205 of FIG. 2, a detailed description thereof will be omitted, and reference may be made to FIG. 2.

In operation 503, the server 10 receives, from the user terminal 20, reference information as part of information on a predetermined interaction to determine whether a condition related to the predetermined interaction is satisfied.

The server 10 may receive the reference information from the user terminal 20. Here, the reference information may serve as a basis for determining an intimacy level. The user may select at least part of relationship information as reference information for determining the intimacy level. For example, the user may determine that only reaction information associated with messages transmitted by user terminal 20 to a chat room and the gift information associated with the user among the relationship information serve as reference information for determining an intimacy level.

The server 10 may receive information on weights associated with the relationship information from the user terminal 20. For example, the user may assign higher weights to the reaction information and the gift information than to other types of relationship information. In addition, the user may assign a lower weight to reply information associated with a message than to other types of relationship information.

The server 10 may receive reference information for each chat room from the user terminal 20. For example, the server 10 may receive reaction information and gift information as the reference information for a first chat room from the user terminal 20. In addition, the server 10 may receive reply information and gift exchange information from the user terminal 20 as reference information for a second chat room.

In some cases, the user may set any message including a predetermined keyword to always be highlighted. For example, another user who sends a message including the predetermined keyword may be determined to have the highest intimacy level with the user.

In some cases, the user may designate a specific user as the user with the highest intimacy level. For example, the user may designate “Team Leader” as the user with the highest intimacy level in a company chat room. In this case, all messages transmitted to the chat room by “Team Leader” may be highlighted.

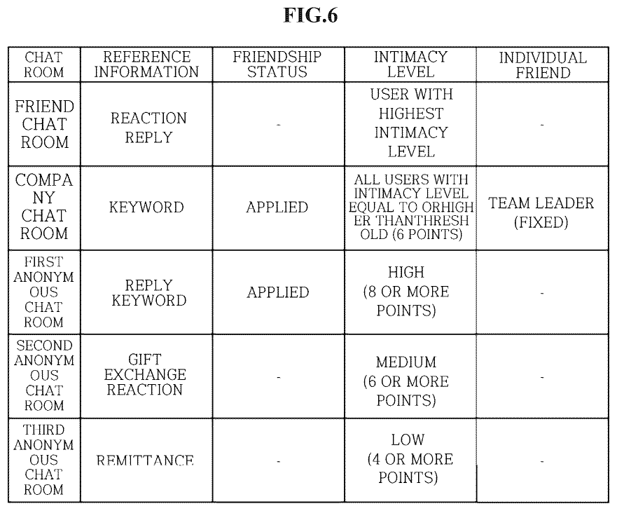

FIG. 6 schematically illustrates a screen where the server 10 stores reference information received from the user terminal 20 according to one embodiment of the present disclosure.

Referring to FIG. 6, the server 10 may receive reference information for determining intimacy level from the user terminal 20. The server 10 may receive reference information for each chat room. For example, the server 10 may receive “Reaction Information” and “Reply Information” for “Friend Chat Room” from the user terminal 20 as reference information. However, the server 10 may receive only “Keyword Information” for the “Company Chat Room” from the user terminal 20 as reference information.

In addition, the server 10 may receive only “Reply Information” and “Keyword Information” for “First Anonymous Chat Room”, “gift exchange information” and “Reaction Information” for “Second Anonymous Chat Room”, and “Remittance Information” for “Third Anonymous Chat Room” as reference information from the user terminal 20.

In addition, the server 10 may receive, from the user terminal 20, reference information indicating whether the user and at least one other user satisfy a specific relationship. For example, the server 10 may receive information on any other user corresponding to “friend relationship” for “Company Chat Room” as reference information from the user terminal 20.

In some cases, the information indicating whether the user and at least one other user satisfy a specific relationship may not be applied as reference information in an anonymous chat room. This is because the server 10 may be unable to determine whether the user and another user satisfy a specific relationship (e.g., a friend relationship) in an anonymous chat room. However, if another user participates in the anonymous chat room using a messenger profile (i.e., a non-anonymous profile), information on whether the user and the other user satisfy a specific relationship may be applied as reference information.

The server 10 may receive different predetermined conditions related to intimacy level from the user terminal 20 for each chat room. For example, the server 10 may receive, from the user terminal 20, a predetermined condition for a “Friend Chat Room,” such as “a message transmitted by the user with the highest intimacy level in the chat room.”

In addition, the server 10 may receive, from the user terminal 20, a predetermined condition for “Company Chat Room,” such as “a message transmitted by another user having an intimacy level equal to or higher than a predefined threshold.” Here, the predefined threshold may be set differently for each chat room.

Specifically, the predefined threshold may be set to “High” (8 or more points) in the first anonymous chat room, “Medium” (6 or more points) in the second anonymous chat room, and “Low” (4 or more points) in the third anonymous chat room.

The server 10 may receive a request from the user terminal 20 to designate all messages transmitted by a specific user terminal as highlight target messages. For example, the server 10 may receive a request from the user terminal 20 to designate all messages transmitted by the “Team Leader” in the “Company Chat Room” as highlight target messages.

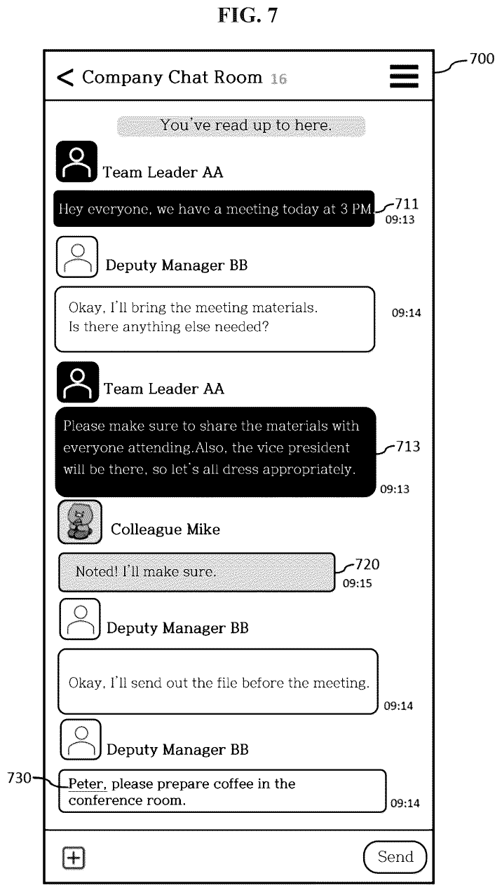

FIG. 7 illustrates a screen where the user terminal 20 displays highlighted messages 711, 713, 720, and 730 according to one embodiment of the present disclosure.

Referring to FIG. 7, there may be a plurality of other users who satisfy a predetermined condition related to intimacy level. Specifically, when the predetermined condition is defined as a message transmitted by another user whose intimacy level is equal to or higher than a predefined threshold, there may be a plurality of other users who satisfy the predetermined condition.

In some cases, a specific user (e.g., Team Leader AA) may be a user that the user has designated as having a high intimacy level in a chat room 700. In this case, all messages 711 and 713 transmitted by the specific user terminal may be displayed as highlighted messages.

In addition, in FIG. 7, “Company colleague Mike” may be another user who is registered by the user as a friend. In this case, when determining an intimacy level, the server 10 may determine the intimacy level of “Company colleague Mike” to be higher than that of any users who are not registered as friends.

Highlighting may be implemented in various ways. For example, the method for highlighting may be displaying highlight target message 711 and 713 in a color distinguishable from other messages transmitted to the chat room 700.

When there is a plurality of other users who satisfy the predetermined condition related to intimacy level, the highlighting for each user may be implemented in different ways. For example, different colors of highlighting may be applied to the messages 711 and 713 transmitted by “Team Leader AA” to the chat room and a message 720 transmitted by “Company colleague Mike” to the chat room.

In some cases, the user may configure highlighting to be applied to all messages including a specific keyword. For example, the user may configure highlighting to be applied to all messages including Peter (the user's own name) 730.

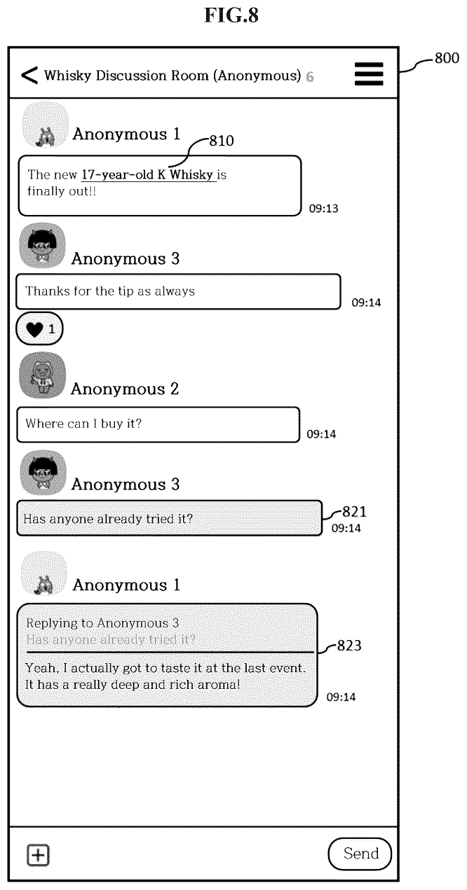

FIG. 8 illustrates a screen where the user terminal 20 displays highlighted messages 810, 821, and 823 in an anonymous chat room 800 according to one embodiment of the present disclosure.

Referring to FIG. 8, the server 10 may determine an intimacy level between the user and another user in the anonymous chat room 800. Specifically, when the chat room is an anonymous chat room, the server 10 may determine an intimacy level based on relationship information for each chat room in which the user is participating in the chat service. For example, the server 10 may determine the intimacy level between the user and another user based solely on relationship information associated with the “Whiskey Discussion Chat Room”800.

The method for highlighting may be determined by the content of a message transmitted by another user. For example, when a message transmitted by another user includes keyword information 810 set by the user, the method for highlighting may be changing the color or size of the keyword.

Alternatively, when another user terminal transmits a message 823 by replying to a message 821 transmitted by the user terminal 20 to the chat room 800, the method for highlighting may be highlighting the original message 821 and the reply message 823 in a color distinguishable from that of other messages in the chat room 800.

A highlight target message may be a message 823 newly transmitted in real time from another user terminal in the chat room 800. Specifically, when the user and another user are engaged in real-time communication in the chat room 800, the most recent message 823 transmitted by another user terminal that satisfies a predetermined condition related to intimacy level may be the highlight target message. In such cases, only the most recent message may be displayed as the highlighted message 823.

However, as shown in FIG. 8, when the most recent message is transmitted to the chat room 800 in the form of a reply, both the original message 821 and the reply message 823 may be displayed as highlighted messages.

Although not shown in the drawing, when a message is transmitted by another user terminal as a reply to a message sent by the user terminal 20 to a chat room, the highlighting may be displayed by presenting the reply message in a separate area (e.g., a thread page).

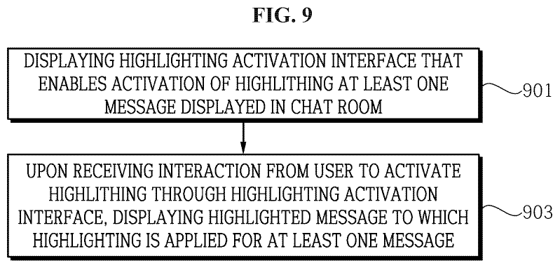

FIG. 9 is a flowchart illustrating a method in which the user terminal 20 of the present disclosure displays a highlighted message.

For convenience of explanation, descriptions of operations in FIG. 13 that are substantially the same as those in FIG. 2 will be omitted, and reference will be made to FIG. 2 instead.

In operation 901, the user terminal 20 displays a highlighting activation interface that enables activation of highlighting for at least one message displayed in a chat room. Since operation 901 is substantially the same as operations 201 to 203 of FIG. 2, a detailed description thereof will be omitted, and reference is made to FIG. 2.

In operation 903, upon receiving an interaction from the user to activate highlighting through the highlighting activation interface, the user terminal 20 displays highlighted messages in which highlighting is applied to at least one message.

The user terminal 20 may determine an intimacy level. Specifically, the user terminal 20 may determine a message-level intimacy score based on message information related to the chat room and stored in the user terminal 20. In addition, the user terminal 20 may receive information on a user-level intimacy score from the server 10. Thereafter, the user terminal 20 may determine the intimacy level between the user and another user based on at least one of a message-level intimacy score and a user-level intimacy score.

When the user terminal 20 determines a message-level intimacy score, there is an advantage in that the user terminal 20 do not need to provide message information stored in the terminal to the server 10.

The present disclosure provides an advantage in determining intimacy levels among users participating in a chat room, and in highlighting at least some of a plurality of messages displayed in the chat room based on the determined intimacy levels.

The present disclosure provides an advantage in offering a method for calculating intimacy levels among users, based on relationship information about other users participating in a chat room, with respect to a message transmitted by a user terminal to the chat room.

The technical features disclosed in each embodiment of the present disclosure are not limited to the corresponding embodiment, and, insofar as they are not mutually incompatible, may be combined with and applied to other embodiments.

Therefore, each embodiment is described with emphasis on respective technical features, but unless the technical features are incompatible with each other, they may be implemented in combination.

The present disclosure is not limited to the above-described embodiments and the accompanying drawings, and various modifications and changes may be made by those skilled in the art to which the present disclosure pertains. Therefore, the scope of the present disclosure should be defined by the claims appended hereto and their equivalents.

What is claimed is:

1. A method for providing information on a highlight target message by a server, comprising:
identifying information on a predetermined interaction between a user and at
least one other user participating in a chat room;
determining whether a condition related to the predetermined interaction between the user and the at least one other user is satisfied based on the information on the predetermined interaction; and
providing information on a highlight target message to a user terminal in response to a message transmitted to the chat room satisfying the condition.

2. The method of claim 1, further comprising:
providing, to the user terminal, a highlighting activation interface that enables activation of highlighting for the highlight target message.

3. The method of claim 1, wherein the information on the predetermined interaction comprises at least one of information on interactions involving a message or information on interactions involving the user.

4. The method of claim 3, wherein the information on the interactions involving the message comprises at least one of reply information, comment information, reaction information, or keyword information specified by the user for the message.

5. The method of claim 4, wherein:
the information on the interactions involving the message comprises corresponding message occurrence information, and
the corresponding message occurrence information comprises information indicating whether a corresponding message to a reference message transmitted by the user terminal is included within a set of consecutive messages defined by a predefined criterion.

6. The method of claim 3, wherein the information on the interactions involving the user comprises at least one of gift exchange information for the user, remittance information, information on whether a chat room in which the user and the at least one other user participate exists in the chat service, or information on whether the user and the at least one other user satisfy a specific relationship in the chat service.

7. The method of claim 3, wherein determining whether the condition related to the predetermined interaction comprises:
determining whether a condition related to the message is satisfied, based on the information on the interactions involving the message; and
wherein satisfaction of the condition related to the message is determined based solely on the chat room.

8. The method of claim 3, wherein determining whether the condition related to the predetermined interaction comprises:
determining whether a condition related to the user is satisfied, based on the information on the interactions involving the user; and
wherein satisfaction of the conditions related to the user is determined based on all chat rooms including the chat room.

9. The method of claim 1, wherein, in response to the chat room being an anonymous chat room in which profile information of the user is not disclosed, the server determines whether the condition is satisfied, based solely on the anonymous chat room.

10. The method of claim 1, further comprising:
prior to determining whether the condition is satisfied, receiving the condition associated with the chat room from the user terminal.

11. The method of claim 1, wherein highlighting the highlight target message is determined based on content included in the highlighted messages transmitted to the chat room.

12. The method of claim 1, wherein the highlight target message comprises at least one message among messages unread by the user in the chat room and messages newly transmitted in real time by at least one other user terminal to the chat room.

13. The method of claim 1, further comprising:
prior to determining whether the condition is satisfied, receiving, from the user terminal, reference information for determining whether the condition is satisfied, from among the information on the predetermined interaction.

14. A server providing information on a highlight target message, comprising:
a memory storing instructions, and a processor configured to execute instructions to:
identify information on a predetermined interaction between a user and at least one other user participating in a chat room;
determine whether a condition related to the predetermined interaction between the user and the at least one other user is satisfied based on the information on the predetermined interaction; and
provide information on a highlight target message to a user terminal in response to a message transmitted to the chat room satisfying the condition.

15. A method for displaying a highlighted message by a user terminal, comprising:
displaying a highlighting activation interface that enables activation of highlighting for at least one message displayed in a chat room; and
upon receiving an interaction from a user through the highlighting activation interface, displaying a highlighted message in which highlighting is applied to the at least one message,
wherein the highlighted message is a message transmitted to the chat room by at least one other user terminal, and
wherein the at least one other user is a user who satisfies a condition related to a predetermined interaction with respect to the user.

16. The method of claim 15, wherein:
the predetermined interaction comprises interactions involving a message and interactions involving the user, and
satisfaction of the condition is determined based on at least one of the interactions involving the message and the interactions involving the user.

17. The method of claim 16, wherein the interactions involving the message are determined based on message information related to the chat room and stored in the user terminal.

18. The method of claim 16, wherein the interactions involving the user are determined based on information received by the user terminal from the server.
